(19) United States
(12) Patent Application Publication
(10) Pub. No.: US 2018/0164824 A1
(43) Pub. Date: Jun. 14, 2018

(54) REMOTE CONTROL SYSTEM AND REMOTE CONTROL METHOD

(71) Applicants: Hyundai Motor Company, Seoul (KR); Kia Motors Corporation, Seoul (KR)

(72) Inventor: Kanghi Yu, Yongin (KR)

(21) Appl. No.: 15/597,559

(22) Filed: May 17, 2017

(30) Foreign Application Priority Data
Dec. 14, 2016 (KR) 10-2016-0170203

(51) Int. Cl. G05D 1/02; H04L 29/08; G05D 1/00; G07C 5/00; G05B 15/02

(52) U.S. Cl. CPC G05D 1/0214; H04L 67/12; H04W 84/005; G07C 5/008; G05B 15/02; G05D 1/0011

(57) ABSTRACT

A remote control system includes: a vehicle having a control unit equipped therein, the control unit configured to transmit user terminal information of a user terminal and vehicle information of the vehicle to a server; the server configured to receive the user terminal information and the vehicle information from the control unit, store user identification information related to the vehicle and a user based on the user terminal information and the vehicle information, and transmit the user identification information in response to receiving a request for the user identification information; and an entry control device configured to identify a vehicle attempting to enter a restricted area, send a request for user identification information associated with the identified vehicle to the server, receive the user identification information associated with the identified vehicle from the server, and determine whether to allow the vehicle to enter the restricted area and whether to perform a predetermined remote control related to the user based on the received user identification information.

### CROSS-REFERENCE TO RELATED APPLICATION

This application claims the benefit of priority to Korean Patent Application No. 10-2016-0170203, filed on Dec. 14, 2016 in the Korean Intellectual Property Office, the disclosure of which is incorporated herein by reference in its entirety.

### BACKGROUND

### 1. Technical Field

Embodiments of the present disclosure generally relate to a remote control system having a vehicle and a server, and a remote control method, and more particularly, to a remote control system having a vehicle and a server, and a remote control method for performing a predetermined remote control based on user information.

### 2. Description of Related Art

“Telematics” is a term that combines telecommunications and informatics. Telematics services are considered to be next-generation automotive information services by combining the information technology (IT) industry and the automotive industry. Examples of telematics services include, for instance, traffic and driving (i.e., navigation) services, emergency response services, and remote vehicle diagnostic services using wireless communications and Global Positioning System (GPS) technology.

### SUMMARY

It is an aspect of the present disclosure to provide a remote control system and a remote control method capable of receiving information, which is related to a user riding a vehicle, from a server and performing a predetermined remote control based on the received user information.

Additional aspects of the present disclosure will be set forth in part in the description which follows and, in part, will be apparent from the description, or may be learned by practice of the present disclosure.

In accordance with embodiments of the present disclosure, a remote control system includes: a vehicle having a control unit equipped therein, the control unit configured to transmit user terminal information of a user terminal and vehicle information of the vehicle to a server; the server configured to receive the user terminal information and the vehicle information from the control unit, store user identification information related to the vehicle and a user based on the user terminal information and the vehicle information, and transmit the user identification information in response to receiving a request for the user identification information; and an entry control device configured to identify a vehicle attempting to enter a restricted area, send a request for user identification information associated with the identified vehicle to the server, receive the user identification information associated with the identified vehicle from the server, and determine whether to allow the vehicle to enter the restricted area and whether to perform a predetermined remote control related to the user based on the received user identification information.

The entry control device may be further configured to allow the vehicle to enter the restricted area and perform the predetermined remote control when information matching the received user identification information is present among pre-stored information associated with objects having entry permission to enter the restricted area.

The predetermined remote control may include operating an air conditioning apparatus, a lighting device, or a home appliance provided in a space in which the user lives.

The control unit may be further configured to acquire the user terminal information via wireless communication with the user terminal.

The server may be further configured to store information related to the user terminal and the vehicle in advance, and further configured to generate and store the user identification information when the user terminal information and the vehicle information transmitted from the control unit matches the pre-stored information.

The control unit may be further configured to update the user terminal information by performing wireless communication with the user terminal for a predetermined period.

When a predetermined event related to a user change occurs, the control unit may be further configured to newly acquire user terminal information of the user terminal, and the newly acquired user terminal information is different from previously acquired user terminal information, the control unit may be further configured to transmit the newly acquired user terminal information to the server.

Furthermore, in accordance with embodiments of the present disclosure, a remote control method includes: transmitting, by a control unit equipped in a vehicle, user terminal information of a user terminal and vehicle information of the vehicle to a server; receiving, at the server, the user terminal information and the vehicle information from the control unit; storing, in the server, user identification information related to the vehicle and a user based on the user terminal information and the vehicle information; identifying, by an entry control device, a vehicle attempting to enter a restricted area; sending, by the entry control device, a request for user identification information associated with the identified vehicle to the server; receiving, at the entry control device, the user identification information associated with the identified vehicle from the server; and determining, by the entry control device, whether to allow the vehicle to enter the restricted area and whether to perform a predetermined remote control related to the user based on the received user identification information.

The remote control method may further include allowing the vehicle to enter the restricted area and performing the predetermined remote control related to the user when information matching the received user identification information is present among pre-stored information associated with objects having entry permission to enter the restricted area.

The remote control method may further include: allowing the vehicle to enter the restricted area when information matching the received user identification information is present among pre-stored information associated with objects having entry permission to enter the restricted area; and operating an air conditioning apparatus, a lighting device, or a home appliance provided in a space in which the user lives.

The remote control method may further include acquiring the user terminal information via wireless communication with the user terminal.

The remote control method may further include: storing information related to the user terminal and the vehicle in advance, and generating and storing the user identification information when the user terminal information and the vehicle information transmitted from the control unit matches pre-stored information.

The remote control method may further include: updating the user terminal information by performing wireless communication with the user terminal for a predetermined period.

The remote control method may further include: newly acquiring user terminal information of the user terminal when a predetermined event related to a user change occurs; and when the newly acquired user terminal information is different from previously acquired user terminal information, transmitting the newly acquired user terminal information to the server.

Furthermore, in accordance with embodiments of the present disclosure, a remote control system includes: a server configured to store user identification information related to a vehicle and a user and transmit the identification information in response to receiving a request for the stored user identification information; and an entry control device configured to identify a vehicle attempting to enter a restricted area, sends a request for user identification information associated with the identified vehicle to the server, receive the user identification information associated with the identified vehicle from the server, and allow the vehicle the restricted area to enter the restricted area and perform a predetermined remote control related to the user when information matching the received user identification information is present among pre-stored information associated with objects having entry permission to enter the restricted area.

The predetermined remote control may include operating an air conditioning apparatus, a lighting device, or a home appliance provided in a space in which the user lives.

The server may be further configured to store information related to the user terminal and the vehicle in advance, and the server may be further configured to generate and store the user identification information when user terminal information of a user terminal and vehicle information of a vehicle transmitted from a control unit equipped in the vehicle matches the pre-stored information.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a view illustrating a configuration of a telematics system.

FIG. 2 is a view illustrating a configuration of a remote control system in accordance with embodiments of the present disclosure.

FIG. 3 is a view illustrating an exterior of a vehicle in accordance with embodiments of the present disclosure.

FIG. 4 is a view illustrating an interior of the vehicle in accordance with embodiments of the present disclosure.

FIG. 5 is a flowchart illustrating a remote control method of the remote control system in accordance with embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

The detailed description discloses the principles of the present disclosure as well as embodiments of the present disclosure so that those skilled in the art will be able to practice the present disclosure. The disclosed embodiments may be implemented in various forms.

Like reference numerals refer to like elements throughout the description. Well-known functions or constructions are not described in detail since they would obscure the one or more exemplar embodiments with unnecessary detail. Terms such as “part” and “portion” may be embodied as hardware or software. According to embodiments, a plurality of “part” and “portion” may be implemented as a single component or a single “part” and “portion” may include a plurality of components. Also, when a part “includes” or “comprises” an element, unless there is a particular description contrary thereto, the part may further include other elements, not excluding the other elements. As used herein, the singular forms “a,” “an” and “the” are intended to include the plural forms as well, unless the context clearly indicates otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

An identification code is used for the convenience of the description but is not intended to illustrate the order of each step. The each step may be implemented in the order different from the illustrated order unless the context clearly indicates otherwise.

Additionally, it is understood that one or more of the below methods, or aspects thereof, may be executed by at least one control unit or controller. The term “control unit” or “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit or controller in conjunction with one or more other components, as would be appreciated by a person of ordinary skill in the art.

Furthermore, the control unit or controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Reference will now be made in detail to embodiments of the present disclosure, examples of which are illustrated in the accompanying drawings.

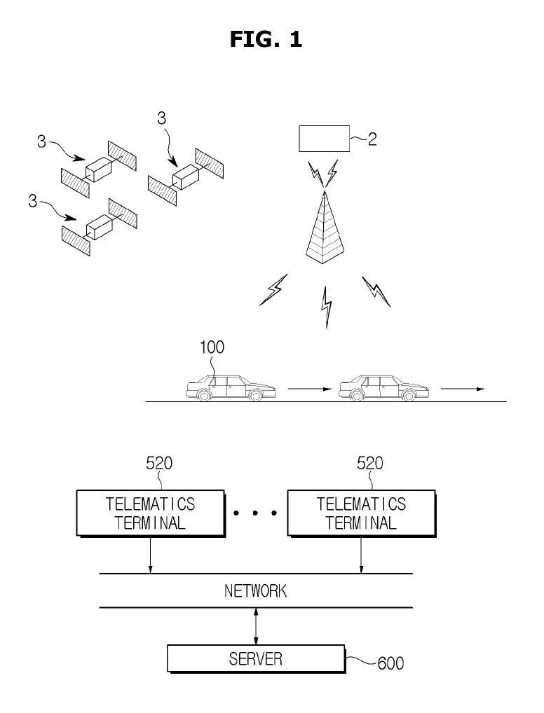

FIG. 1 is a view illustrating a configuration of a telematics system. As illustrated in FIG. 1, according to embodiments of the present disclosure, a telematics system may include a telematics terminal 520 provided in a vehicle 100 and a server 600 provided in a telematics center 2.

The telematics terminal 520 may be installed in the vehicle 100 and configured to communicate with the server 600 via the network. The telematics terminal 520 may be installed in the vehicle 100, as mentioned above, or alternatively, the telematics terminal 520 may be implemented as a variety of terminals capable of communicating with the server 600 in a state in which the telematics terminal 520 is not installed in the vehicle 100. For example, the telematics terminal 520 may be implemented by a computer or a mobile terminal that can be connected to the server 600 via the network. The computer may include a notebook, a desktop, a laptop, a tablet PC, and a slate PC in which Web Browser is loaded. The mobile terminal may be a wireless communication device configured to secure the portability and mobility and may include all kind of a wireless communication device based on a handheld method, e.g., Personal Communication System (PCS), Global System for Mobile (GSM) communication, Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, smart phone, and so forth.

According to embodiments of the present disclosure, the telematics terminal 520 may include a communicator configured to communicate with the server 600 as mentioned above, and the communicator may include one or more components. For example, the communicator may include a wireless communication module, and additionally include at least one of a short range communication module and a wired communication module. The wireless communication module may include a wireless communication module supporting a variety of wireless communication methods, e.g., Wifi module, Wireless broadband module, global System for Mobile (GSM) Communication, Code Division Multiple Access (CDMA), Wideband Code Division Multiple Access (WCDMA), Time Division Multiple Access (TDMA), Long Term Evolution (LTE), and so forth.

The wireless communication module may include a wireless communication interface provided with a communication port connecting the network to the controller of the telematics terminal 520, a transmitter transmitting a signal for providing the telematics service and a receiver receiving a signal related to providing the telematics service. The wireless communication module may further include a signal conversion module configured to modulate a digital control signal output from the controller via the wireless communication interface under the control of the controller, into a radio signal in the analog form, and configured to demodulate the radio signal in the analog form, which is received via the wireless communication interface, into a digital control signal. The controller may be included in the telematics terminal 520 and implemented using a memory storing an algorithm and program type data to control an operation of each component of the telematics terminal 520 and a processor performing the above mentioned operation using the data stored in the memory. The memory and the processor may be implemented in separate chips, or a single chip. The controller may be included in the telematics terminal 520, as mentioned above, or alternatively provided on the outside of the telematics terminal 520 and configured to control the overall configuration of the vehicle.

The short-range communication module may include a variety of short range communication modules, which is configured to transmit and receive a signal using a wireless communication module in the short range, e.g., Bluetooth module, Infrared communication module, Radio Frequency Identification (RFID) communication module, Wireless Local Access Network (WLAN) communication module, NFC communications module, ZigBee communication module, and so forth. The wired communication module may include a variety of wired communication module, e.g., Controller Area Network (CAN) communication module, Local Area Network (LAN) module, Wide Area Network (WAN) module, or Value Added Network (VAN) module and a variety of cable communication module, e.g., Universal Serial Bus (USB), High Definition Multimedia Interface (HDMI), Digital Visual Interface (DVI), and so forth.

The telematics terminal 520 may receive GPS signals from at least three GPS satellites 3 and calculate a current position of the vehicle 100 based on the GPS signals and map data. In a state in which a route from the current position of the vehicle 100 to a destination is set, the telematics terminal 520 may transmit information related to the current position of the vehicle 100 on the map to the server 600. The telematics terminal 520 may transmit vehicle driving images captured by a black box or a recording device and vehicle driving images stored in the storage, to the server 600. As mentioned above, the telematics terminal 520 may transmit a variety of data related to the vehicle 100 to the server 600. The storage may be a storage included in the telematics terminal 520 or included in the vehicle 100 instead of being included in the telematics terminal 520. The storage may be an external memory that is not included in the vehicle 100. The storage may be implemented using at least one of a non-volatile memory element, e.g., a cache, a Read Only Memory (ROM), a Programmable ROM (PROM), an Erasable Programmable ROM (EPROM), an Electrically Erasable Programmable ROM (EEPROM) and a flash memory, a volatile memory element, e.g., a Random Access Memory (RAM), or a storage medium, e.g., a Hard Disk Drive (HDD) and a CD-ROM. The implementation of the storage is not limited thereto. The storage may be a memory that is implemented by a separate memory chip from the aforementioned processor or the storage may be implemented by a processor and a single chip.

The server 600 may receive a variety of data related to vehicle driving images from the telematics terminal 520, and store the data. The server 600 may receive a signal related to a certain telematics service and provide a telematics service corresponding to the received signal. In addition, the server 600 may pre-store information for identifying a vehicle, and receive information related to a user terminal 400 belonging to a user, in advance and store the information. The server 600 may store the identification information of the vehicle and the identification information of the user terminal 400 belonging to the user by matching both the identification information, and thus the server 600 may determine the user information based on the vehicle information and determine the vehicle information based on the user information.

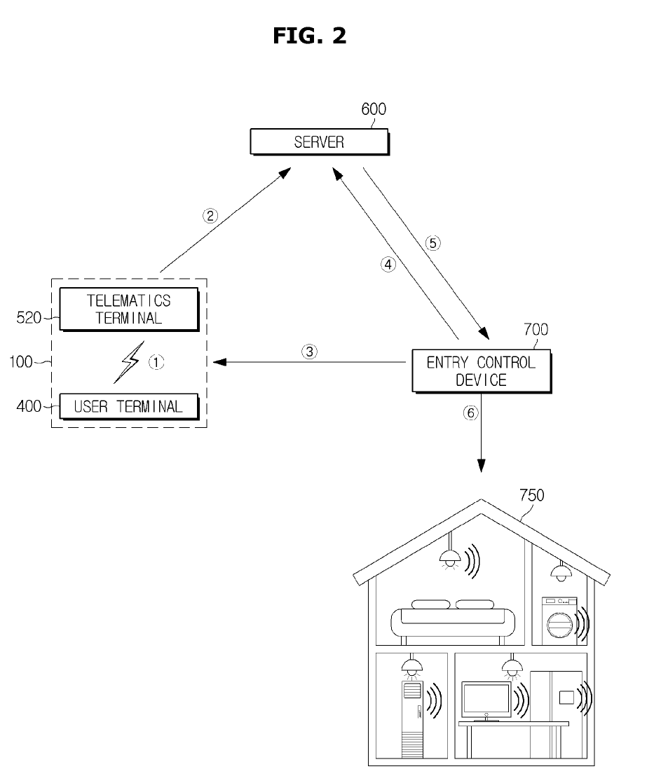

According to embodiments of the present disclosure, it may be possible to provide a remote control system having an entry control device 700 configured to receive the user information from the server 600 when the vehicle is identified, and configured to identify a passenger of the vehicle based on the received user information, thereby performing a predetermined remote control related to an identified user. That is, the remote control system may identify a user of a vehicle and perform a remote control that is automated for an external device and appropriately pre-set for the identified user. Hereinafter a description thereof will be described in details with reference to FIGS. 2 to 5.

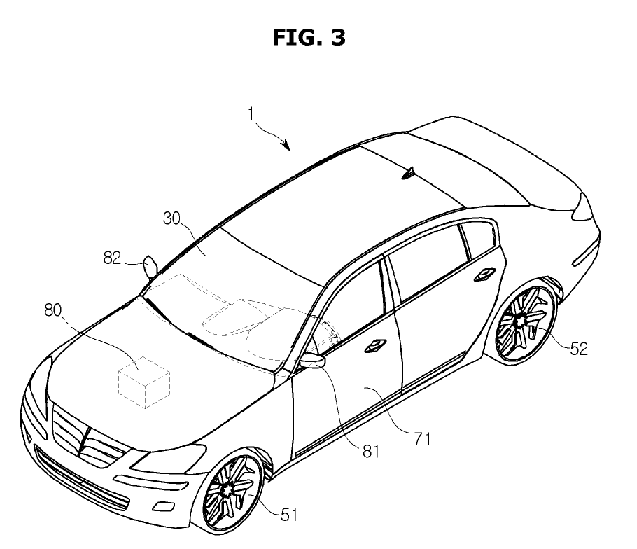

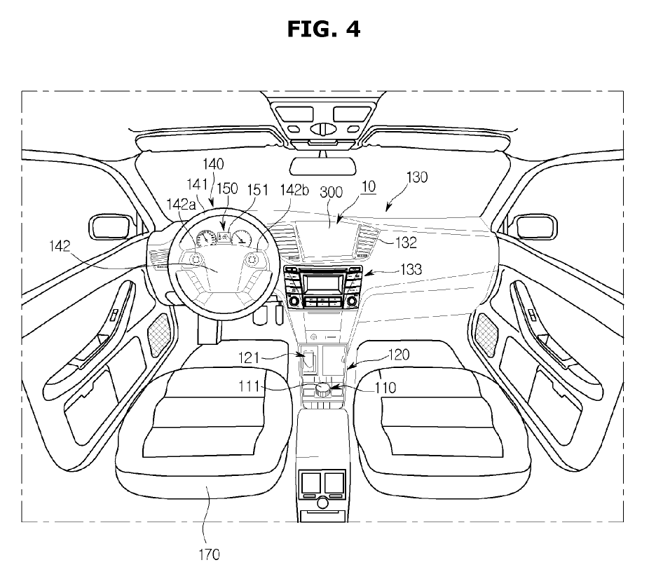

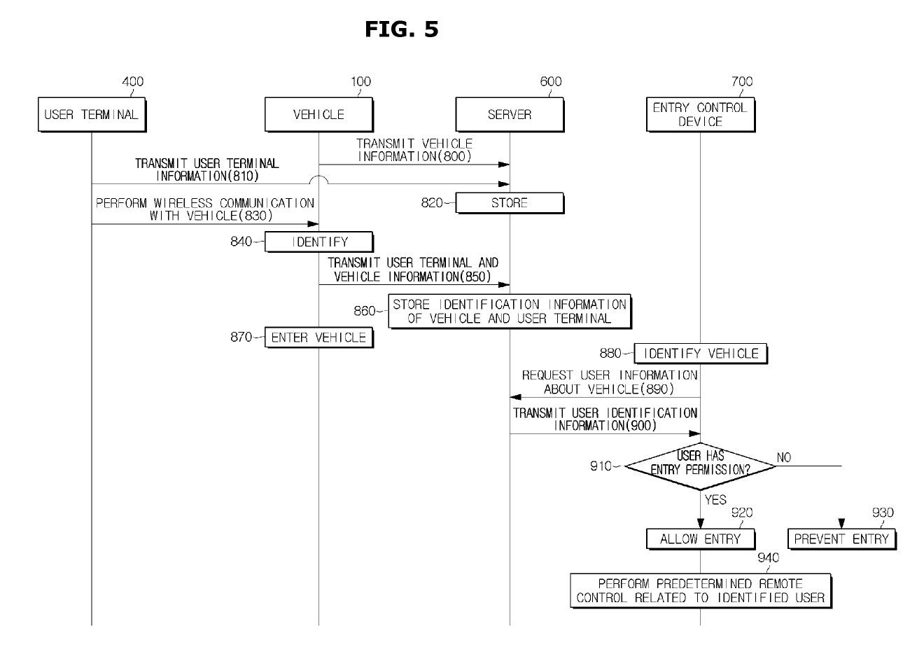

FIG. 2 is a view illustrating a configuration of a remote control system in accordance with embodiments of the present disclosure, FIG. 3 is a view illustrating an exterior of a vehicle in accordance with embodiments of the present disclosure, FIG. 4 is a view illustrating an interior of the vehicle in accordance with embodiments of the present disclosure, and FIG. 5 is a flowchart illustrating a remote control method of the remote control system in accordance with embodiments of the present disclosure.

Referring first to FIG. 2, the remote control system may include a vehicle configured to acquire information of the user terminal 400 and transmit the information to the server 600, the entry control device 700 configured to identify a vehicle that attempts to enter a restricted area and configured to request user information of the identified vehicle to the server 600, and the server 600 configured to transmit the user identification information to the entry control device 700 in response to the request of the entry control device 700.

The vehicle will be described with reference to FIGS. 3 and 4. It should be understood that the exterior and interior of the vehicle 100 are not limited solely to the configuration illustrated in FIGS. 3 and 4 and described herein. Rather, the configuration illustrated in FIGS. 3 and 4 and described herein is provided merely for demonstration purposes, and thus does not limit the scope of the present disclosure or claims.

According to embodiments of the present disclosure, the vehicle 100 may include a body 10 forming an exterior of the vehicle 100, vehicle wheels 51 and 52 moving the vehicle 100, a driver 80 rotating the vehicle wheels 51 and 52, a door 71 closing the inside of the vehicle 100 from the outside, a front glass 30 providing a front view of the vehicle 100 to a driver inside the vehicle 100, and side mirrors 81 and 82 providing a view of a rear side of the vehicle 100 to the driver.

The vehicle wheels 51 and 52 may include a front wheel 51 provided on a front of the vehicle 100 and a rear wheel 52 provided on a rear of the vehicle 100.

The driver 80 may supply a torque to the front wheel 51 and the rear wheel 52 so that the body 1 may be moved forward and backward. The driver 80 may employ an engine configured to generate a torque by burning fossil fuel or a motor configured to generate a torque by receiving power source from a battery or a fuel cell. When the driver 80 includes the motor, the driver 80 may include an inverter configured to control the rotation of the motor.

The door 71 may be rotatably provided on a right side and a left side of the body 1. When the door 71 is opened, a driver may be allowed to be seated in the vehicle 100, and when the door 71 is closed, the inside of the vehicle 100 may be closed from the outside.

The front glass 30 referred to as “windshield glass” may be provided on an upper portion of the front of the body 1 to allow a driver inside the vehicle 100 to acquire visual information about the front of the vehicle 100. The side mirrors 81 and 82 may include a left side mirror 81 provided on the left side of the body 1 and a right side mirror 82 provided on the right side of the body 1. The side mirrors 81 and 82 may allow a driver inside the vehicle 100 to acquire visual information of the lateral side and the rear side of the vehicle 100.

In addition, the vehicle 100 may include a variety of sensors to help the driver to recognize the situation of the vehicle 100 by detecting an obstacle in the surroundings of the vehicle 100. The vehicle 100 may include a variety of sensors capable of sensing driving information of the vehicle, e.g., a speed of the vehicle. Further, the vehicle may include a sensor configured to acquire an image of the surrounding environment of the vehicle, e.g., a lane.

Referring next to FIG. 3, the vehicle 100 may include a dashboard in which a gear box 120, a center fascia 130, a steering wheel 140 and an instrument panel 150 are provided.

In the gear box 120, a gear lever 121 configured to change a speed of the vehicle may be installed. In addition, as illustrated the drawings, an input 110 provided with a dial operator 111 and a variety of buttons configured to allow a user to control a function of a multimedia device including a navigation system 10 or an audio device 133 and configured to allow a user to control performing main function of the vehicle may be installed. In the center fascia 130, an air conditioning device 132, the audio device 133 and the navigation system 10 may be installed.

As mentioned above, the vehicle 100 may include the telematics terminal 520 configured to communicate with the server 600 via the network. According to the embodiment, the telematics terminal 520 may be installed in the vehicle 100. As mentioned above, the telematics terminal 520 may be configured to include a communicator capable of performing a wired and/or wireless communication, and may be provided as an additional device separated from other devices or provided to be included in other device having a communication function. For example, the telematics terminal 520 may be implemented as a navigation device having a communicator configured to perform the wired and/or wireless communication.

The telematics terminal 520 may identify the user terminal 400 using the wireless communication with the user terminal 400 of the vehicle passenger, as well as the communication with the server 600 (\textcircled{1}). The user terminal 400 may include all kinds of wireless communication devices based on the handheld e.g., a smart phone. The telematics terminal 520 may receive the information of the user terminal 400 via the communication with the user terminal 400 using the short range communication, e.g., Bluetooth, Wifi, Infrared communication, Radio Frequency Identification (RFID) communication, Wireless Local Access Network (WLAN) communication, NFC communication, ZigBee communication, and the like. Thus, the telematics terminal 520 may acquire the information of the user terminal 400. The information of the user terminal 400 may include identification information configured to distinguish the corresponding user terminal 400 from other user terminal 400. When the telematics terminal 520 acquires the information of the user terminal 400, the telematics terminal 520 may transmit the acquired information of the user terminal 400 and the vehicle information configured to identify the corresponding vehicle, to the server 600 (\textcircled{2}). A detail description thereof will be described later.

The air conditioning device may keep an air inside the vehicle 100 fresh by controlling temperature, humidity, air cleanliness, and flow of air of the inside of the vehicle 100. The air conditioning device may include at least one discharging port installed in the center fascia 130 and configure to discharge air. A button or a dial may be installed in the center fascia 130 to control the air conditioning device. A user, such as a driver, may control the air conditioning device by using a button or a dial disposed on the center fascia 130. Also, the user may control the air conditioning device by using the buttons or the dial operator 111 of the input 110 installed in the gear box 120.

The navigation system 10 may be installed in the center fascia 130. The navigation system 10 may be formed to be embedded in the center fascia 130 of the vehicle 100. According to embodiments of the present disclosure, an input configured to control the navigation system 10 may be installed in the center fascia 130. Alternatively, the input of the navigation system 10 may be installed in another position other than the center fascia 130. For example, the input of the navigation system 10 may be formed around a display 300 of the navigation system 10. Alternatively, the input of the navigation system 10 may be installed in the gear box 120.

A steering wheel 140 may be a device configured to adjust a driving direction of the vehicle 100, and may include a rim 141 held by the driver and a spoke 142 connected to a steering system of the vehicle 100 and configured to connect the rim 141 to a hub of a rotation shaft for the steering. According to the embodiment, manipulation devices 142a and 142b may be formed in the spoke 142 to control various devices inside the vehicle 100, such as an audio device. In addition, in the dashboard, the instrument panel 150 indicating driving speed of the vehicle and revolutions per minute (RPM) or fuel residual quantity may be installed. The instrument panel 150 may include an instrument panel display 151 configured to display the vehicle conditions, information related to the vehicle driving, and information related to the operation of the multimedia device.

A driver may drive the vehicle 100 by operating the above mentioned various devices provided in the dashboard.

When receiving the user terminal information and the vehicle information transmitted from the telematics terminal 520 of the vehicle 100, the server 600 may compare the received user terminal information with pre-stored user terminal information, and generate user identification information by identifying a user that is indicated by the received user terminal information. In addition, the server 600 may identify the vehicle 100 by comparing the received vehicle information with pre-stored vehicle information and store the identified vehicle information and the user identification information. The server 600 may generate identification information about which user rides which vehicle 100 by receiving the vehicle information and the user terminal information transmitted from the vehicle 100, and then the server 600 may store the identification information.

As mentioned above, the telematics terminal 520 of the vehicle 100 may acquire the user terminal information via the wireless communication with the user terminal 400 and the telematics terminal 520 may update the information of the user terminal 400 by performing the wireless communication with the user terminal 400 by a predetermined period. When the user terminal 400 is changed, since the user riding the vehicle 100 is changed, the vehicle 100 may acquire information of the user terminal 400 belonging to the changed user and transmit the information to the server 600. Therefore, the vehicle 100 may maintain the user terminal information transmitted from the server 600, as the latest information.

When an event in which the passenger of the vehicle 100 is changed is detected, the telematics terminal 520 of the vehicle 100 may perform the wireless communication with the user terminal 400. For example, when the event, e.g., the driver stops driving the vehicle 100, the door of the vehicle 100 is opened, or a detection result of a weight sensor in a seat of the vehicle 100 is changed, is detected, the telematics terminal 520 of the vehicle 100 may perform the wireless communication with the user terminal 400, again and acquire new information of the user terminal 400. The above mentioned event is merely an example, and thus the event may include various other changes related to changing a passenger.

As mentioned above, the telematics terminal 520 may determine that a passenger is changed when the information of the user terminal 400 that is acquired in the latest is different from the information of the user terminal 400 that is previously acquired, and then the telematics terminal 520 may transmit the new user terminal information to the server 600. When the new user terminal information is transmitted from the vehicle 100, the server 600 may update the user identification information related to the corresponding vehicle 100, based on the new user terminal information and store the updated information.

The entry control device 700 may be a device configured to block or allow an entry of the vehicle 100 into a restricted area such as, for example, a parking building, and the entry control device 700 may include a detector, e.g., a camera, configured to detect an object, e.g., a vehicle number or a tag attached to the vehicle 100, identifying the vehicle 100, a communicator configured to transmit vehicle information detected by the camera and configured to receive user identification information from the server 600, a storage configured to store information related to an object having entry permission, and a blocking device configured to block or allow entry into the restricted area.

When the camera of the entry control device 700 acquires an image of a vehicle number, and thus the vehicle 100 is identified (\textcircled{3}), the entry control device 700 may ask the server 600 to transmit the user identification information of the corresponding vehicle 100 while transmitting the identified vehicle information to the server 600 via the communicator (\textcircled{4}).

When the server 600 receives the vehicle identification information from the entry control device 700, the server 600 may determine whether vehicle identification information corresponding to the received vehicle identification information is present in pre-stored vehicle identification information. When the vehicle identification information, which matches with the vehicle identification information received from the entry control device 700, is present, the server 600 may transmit the user identification information indicating information about a passenger of the corresponding vehicle 100, to the entry control device 700 (\textcircled{5}).

When the entry control device 700 receives the user identification information from the server 600, the entry control device 700 may determine whether an object matching with the user identification information is present among objects which are stored in the storage and have the entry permission. When the matched object is present, the entry control device 700 may allow the entry of the vehicle 100 into the restricted area by opening the blocking device.

As for a user who is determined as an object having the entry permission, when a pre-stored remote control object is present, the entry control device 700 may perform a remote control on the corresponding object (\textcircled{6}).

For example, as illustrated in FIG. 2, as for the user who is determined as an object having the entry permission, the entry control device 700 may remotely operate a control object including a lighting device, a home appliance, e.g., a washing machine, a television, and a refrigerator, and an air conditioning apparatus, e.g., an air conditioner, which are provided in a user's living space 750. The remote control object may be pre-selected and stored. A particular control target of the control object, e.g., an operation time or a target temperature may be pre-set according to individual user.

The entry control device 700 may perform other functions other than the above mentioned remote control on the living space. For example, in a state in which the vehicle 100 attempts to enter a fitness center, when the user of the corresponding vehicle 100 is determined as an object having the entry permission, the entry control device 700 may automatically check an attendance of the user in the fitness center.

A remote control method of the above mentioned remote control system will be described in details with reference to FIG. 5.

As shown in FIG. 5, the server 600 may receive and store user terminal information and vehicle information from the user terminal 400 and the vehicle 100 in advance (800, 810, and 820). When a user rides the vehicle 100, the vehicle 100 may perform the wireless communication with the user terminal 400 (830) and identify the user terminal 400 (840), and transmit the user terminal information and the vehicle information to the server 600 (850). The server 600 may store the user terminal information and the vehicle information transmitted from the vehicle 100 (860).

The telematics terminal 520 may identify the user terminal 400 via the wireless communication with the user terminal 400 of a passenger of the vehicle 100. The telematics terminal 520 may receive information of the user terminal 400 via the short range communication with the user terminal 400, and acquire the information of the user terminal 400. The information of the user terminal 400 may include identification information configured to distinguish the corresponding user terminal 400 from other user terminal 400. When receiving the information of the user terminal 400, the telematics terminal 520 may transmit the vehicle information configured to identify the acquired information of the user terminal 400 and the corresponding vehicle 100, to the server 600.

When receiving the user terminal information and the vehicle information transmitted from the telematics terminal 520 of the vehicle 100, the server 600 may compare the received user terminal information with pre-stored user terminal information, and generate user identification information by identifying a user that is indicated by the received user terminal information. In addition, the server 600 may identify the vehicle 100 by comparing the received vehicle information with pre-stored vehicle information and store the identified vehicle information and the user identification information. The server 600 may generate identification information about which user rides which vehicle 100 by receiving the vehicle information and the user terminal information transmitted from the vehicle 100, and then the server 600 may store the identification information.

As mentioned above, the telematics terminal 520 of the vehicle 100 may acquire the user terminal information via the wireless communication with the user terminal 400 and the telematics terminal 520 may update the information of the user terminal 400 by performing the wireless communication with the user terminal 400 by a predetermined period. When the user terminal 400 is changed, since the user riding the vehicle 100 is changed, the vehicle 100 may acquire information of the user terminal 400 belonging to the changed user and transmit the information to the server 600. The vehicle 100 may maintain the user terminal information transmitted from the server 600, as the latest information.

When an event in which the passenger of the vehicle 100 is changed is detected, the telematics terminal 520 of the vehicle 100 may perform the wireless communication with the user terminal 400. For example, when the event, e.g., the vehicle 100 stops it's driving, the door of the vehicle 100 is opened, or a detection result of a weight sensor in a seat of the vehicle 100 is changed, is detected, the telematics terminal 520 of the vehicle 100 may perform the wireless communication with the user terminal 400, again and acquire new information of the user terminal 400. The above mentioned event is merely an example, and thus the event may include various other changes related to changing a passenger.

As mentioned above, the telematics terminal 520 may determine that a passenger is changed when the information of the user terminal 400 that is acquired in the latest is different from the information of the user terminal 400 that is previously acquired, and then the telematics terminal 520 may transmit the new user terminal information to the server 600. When the new user terminal information is transmitted from the vehicle 100, the server 600 may update the user identification information related to the corresponding vehicle 100, based on the new user terminal information and store the updated information.

When the vehicle 100 enters (870) a restricted area, the entry control device 700 may identify the vehicle 100 (880), and then request user information about the vehicle 100 (890). The server 600 may transmit the user identification information to the entry control device 700 in response to the request of the entry control device 700 (900). When receiving the user identification information from the server 600, the entry control device 700 may determine whether or not a passenger of the entering vehicle 100 has entry permission (910). When the passenger has the entry permission, the entry control device 700 may allow the entry of the vehicle 100 (920) into the restricted area, and when the passenger does not have the entry permission, the entry control device 700 may block the entry of the vehicle 100 (930). The entry control device 700 may perform a predetermined remote control related to the user having the entry permission (940).

When the entry control device 700 identifies the vehicle 100 by acquiring an image about a vehicle number by the camera thereof, the entry control device 700 may ask the server 600 to transmit user identification information of the corresponding vehicle 100 while transmitting the identified vehicle information to the server 600 via the communicator.

When the server 600 receives the vehicle identification information from the entry control device 700, the server 600 may determine whether vehicle identification information corresponding to the received vehicle identification information is present in pre-stored vehicle identification information. When the vehicle identification information, which matches with the vehicle identification information received from the entry control device 700, is present, the server 600 may transmit the user identification information indicating information about a passenger of the corresponding vehicle 100, to the entry control device 700.

When the entry control device 700 receives the user identification information from the server 600, the entry control device 700 may determine whether an object matching with the user identification information is present among objects which are stored in the storage and have the entry permission. When the matched object is present, the entry control device 700 may allow the entry of the vehicle 100 into the restricted area by opening the blocking device.

If a user is determined as an object having entry permission, when a pre-stored remote control object is present, the entry control device 700 may perform a remote control on the corresponding object. For example, as illustrated in FIG. 2, the user is determined as an object having entry permission. As a result, the entry control device 700 may remotely operate a control object such as a lighting device, a home appliance (e.g., a washing machine, a television, a refrigerator, etc.), an air conditioning apparatus, or the like, which are provided in a user's living space 750. The remote control object may be pre-selected and stored. A particular control target of the control object, e.g., an operation time or a target temperature may be pre-set according to individual user.

The entry control device 700 may perform other functions other than the above mentioned remote control on the living space. For example, in a state in which the vehicle 100 attempts to enter a fitness center, when the user of the corresponding vehicle 100 is determined as an object having the entry permission, the entry control device 700 may automatically check an attendance of the user in the fitness center.

As is apparent from the above description, according to the proposed remote control system and remote control method, it may be possible to identify a user by simply riding a vehicle with holding a user terminal, e.g., a smart phone, and it may be possible to automatically provide a predetermined-personalized service for the identified user.

Although select embodiments of the present disclosure have been shown and described herein, it would be appreciated by those skilled in the art that changes may be made in these embodiments without departing from the principles and spirit of the disclosure, the scope of which is defined in the claims and their equivalents.

### DESCRIPTION OF SYMBOLS

400: user terminal
520: telematics terminal
600: server

What is claimed is:

1. A remote control system comprising:
a vehicle having a control unit equipped therein, the control unit configured to transmit user terminal information of a user terminal and vehicle information of the vehicle to a server;
the server configured to receive the user terminal information and the vehicle information from the control unit, store user identification information related to the vehicle and a user based on the user terminal information and the vehicle information, and transmit the user identification information in response to receiving a request for the user identification information; and
an entry control device configured to identify a vehicle attempting to enter a restricted area, send a request for user identification information associated with the identified vehicle to the server, receive the user identification information associated with the identified vehicle from the server, and determine whether to allow the vehicle to enter the restricted area and whether to perform a predetermined remote control related to the user based on the received user identification information.

2. The remote control system of claim 1, wherein
the entry control device is further configured to allow the vehicle to enter the restricted area and perform the predetermined remote control when information matching the received user identification information is present among pre-stored information associated with objects having entry permission to enter the restricted area.

3. The remote control system of claim 1, wherein
the predetermined remote control includes operating an air conditioning apparatus, a lighting device, or a home appliance provided in a space in which the user lives.

4. The remote control system of claim 1, wherein
the control unit is further configured to acquire the user terminal information via wireless communication with the user terminal.

5. The remote control system of claim 1, wherein
the server is further configured to store information related to the user terminal and the vehicle in advance, and
the server is further configured to generate and store the user identification information when the user terminal information and the vehicle information transmitted from the control unit matches the pre-stored information.

6. The remote control system of claim 1, wherein
the control unit is further configured to update the user terminal information by performing wireless communication with the user terminal for a predetermined period.

7. The remote control system of claim 1, wherein
when a predetermined event related to a user change occurs, the control unit is further configured to newly acquire user terminal information of the user terminal, and
when the newly acquired user terminal information is different from previously acquired user terminal information, the control unit is further configured to transmit the newly acquired user terminal information to the server.

8. A remote control method comprising:
transmitting, by a control unit equipped in a vehicle, user terminal information of a user terminal and vehicle information of the vehicle to a server;
receiving, at the server, the user terminal information and the vehicle information from the control unit;
storing, in the server, user identification information related to the vehicle and a user based on the user terminal information and the vehicle information;
identifying, by an entry control device, a vehicle attempting to enter a restricted area;
sending, by the entry control device, a request for user identification information associated with the identified vehicle to the server;
receiving, at the entry control device, the user identification information associated with the identified vehicle from the server; and
determining, by the entry control device, whether to allow the vehicle to enter the restricted area and whether to perform a predetermined remote control related to the user based on the received user identification information.

9. The remote control method of claim 8, further comprising
allowing the vehicle to enter the restricted area and performing the predetermined remote control related to the user when information matching the received user identification information is present among pre-stored information associated with objects having entry permission to enter the restricted area.

10. The remote control method of claim 8, further comprising:
allowing the vehicle to enter the restricted area when information matching the received user identification information is present among pre-stored information associated with objects having entry permission to enter the restricted area; and
operating an air conditioning apparatus, a lighting device, or a home appliance provided in a space in which the user lives.

11. The remote control method of claim 8, further comprising
acquiring the user terminal information via wireless communication with the user terminal.

12. The remote control method of claim 8, further comprising:
storing information related to the user terminal and the vehicle in advance; and
generating and storing the user identification information when the user terminal information and the vehicle information transmitted from the control unit matches pre-stored information.

13. The remote control method of claim 8, further comprising
updating the user terminal information by performing wireless communication with the user terminal for a predetermined period.

14. The remote control method of claim 8, further comprising:
newly acquiring user terminal information of the user terminal when a predetermined event related to a user change occurs; and
when the newly acquired user terminal information is different from previously acquired user terminal information, transmitting the newly acquired user terminal information to the server.

15. A remote control system comprising:
a server configured to store user identification information related to a vehicle and a user and transmit the identification information in response to receiving a request for the stored user identification information; and
an entry control device configured to identify a vehicle attempting to enter a restricted area, sends a request for user identification information associated with the identified vehicle to the server, receive the user identification information associated with the identified vehicle from the server, and allow the vehicle the restricted area to enter the restricted area and perform a predetermined remote control related to the user when information matching the received user identification information is present among pre-stored information associated with objects having entry permission to enter the restricted area.

16. The remote control system of claim 15, wherein
the predetermined remote control includes operating an air conditioning apparatus, a lighting device, or a home appliance provided in a space in which the user lives.

17. The remote control system of claim 15, wherein
the server is further configured to store information related to the user terminal and the vehicle in advance, and
the server is further configured to generate and store the user identification information when user terminal information of a user terminal and vehicle information of a vehicle transmitted from a control unit equipped in the vehicle matches the pre-stored information.
